(19) United States
(12) Patent Application Publication
(10) Pub. No.: US 2005/0120570 A1
(43) Pub. Date: Jun. 9, 2005

(54) Mechanical celestial navigation and directional device

(76) Inventor: Arthur L. Bastian, Pleasant Grove, UT (US)

Correspondence Address: ARTHUR L. BASTIAN, 597 East Center St., Pleasant Grove, UT, 84062, US

(21) Appl. No.: 10/966,763

(22) Filed: Oct. 14, 2004

Related U.S. Application Data
(60) Provisional application No. 60/511,723, filed on Oct. 15, 2003.

(51) Int. Cl. G01C 17/34

(52) U.S. Cl. 33/268

(57) ABSTRACT

This device computes position, direction, course, azimuth, altitude, and time for any longitude and latitude on earth. It will solve any spherical triangle problem. It can be independent of any electrical power. It is to celestial navigation what the slide rule is to mathematics. It is very educational. It not only solves the celestial navigational problem without the massive charts, but it shows you in a visual way how you are getting the solution. One might ask, Why do we need a mechanical celestial navigational device in this day of global positioning systems, computers, and calculators? There are at least two reasons. 1. This device would be an outstanding backup to the G.P.S.'s, Computers, and Calculators. In celestial navigation it will not totally replace the sextant but the charts can be smaller, simpler, and may not change as often. 2. This device is much more accurate than a magnetic compass, much easier to use, and the complicated gyrations done to compute a magnetic course can be left to a backup role for the magnetic compass. This device is very accurate while in motion, gives instantaneous reading in turns and after banked turns, it is free of effects of metal and electromagnetic interference. A possible third reason for some might be the absence of electromagnetic radiation from it, and no effect of electromagnetic radiation on it. So this device will serve a primary role in direction finding, including dead reckoning, triangulation, and course maintenance. It will serve as a back up to G.P.S.'s, computers, and calculators. It will take the place of sundials, except for those collectors and those who prefer ornaments.

Reference to Provisional application No. 60/511,723

### TECHNICAL FIELD

For thousands of years the standard for directional guidance has been the magnetic compass. For centuries the method for celestial navigation has been the sextant and charts. There are very modern accurate navigational methods in this modern time. However the back-up is still the sextant and charts, and the standard for directional guidance is still the magnetic compass.

This Mechanical Celestial Navigation and Direction Device, solves spherical triangle problems thereby solving navigational problems without the conventional charts, without mathematical formulas, without computers, without batteries, or electricity. This device uses the azimuth of the celestial bodies as the reference for direction. This device is to celestial navigation as the slide rule is to mathematics.

### PRIOR ART

The magnetic compass is based on a sound tried and tested principle of the needle pointing to the magnetic north pole. There has been other tries to use the sun to be a compass. They have all tried to get the device to point north and then get your directions from there. They have used complex graphs, and charts to show which way is north. Then your direction is determined from there.

This Mechanical Celestial Navigation and Direction device does not use that. It finds the celestial bodies azimuth (in relation to true north) lining that up with the direction you want to find and then the shadow of the sun or the sighting of the celestial body across the special compass rose tells you the direction that the device is pointing, not which direction the needle or shadow is pointing.

The compass rose has for centuries has been displayed in a clockwise incrementing of the degrees. Where this invention has the degrees displayed counter clockwise, due to the fact that it is the shadow or a sighting across the compass rose that points or shows which direction you are traveling in or that your object is from you.

Gyros have improved the inherent problems with balancing a magnetic needle on a point to show direction. Magnetic flux devices have helped to continually update the gyros to magnetic north. But nothing has been done to improve the inherit problems of the magnetic compass in determining our direction. How often is the variation checked, how accurate is it, how much deviation is there in the lines of variation. Plus the magnetic field is changing, with more drastic changes forecast, and is affected by electromagnetic waves, and metallic items. In using the magnetic compass there are numerous corrections that have to be made. While in planning variation and deviation have to be applied to the true course, then during use there are the turning, acceleration, lead, lag, errors that have to be accounted for. In use also to do any triangulation with the magnetic compass you have to convert between magnetic and true courses.

This device is as accurate as you can set the variables into the device. The device instantaneously shows the direction as soon as it is level. There is no turning, acceleration, lead, lag, errors, no deviation, or variation. There is refraction, through the atmosphere or through glass. Probably the biggest advantage is that you will plot a true course and then you will navigate the same course instead of plotting a true course and then applying all the corrections to arrive at a magnetic course. This will make triangulation much easier and faster. The suns shadow is unique because the suns light rays are striking the earth parallel throughout the whole earth, making the angles found from the shadow uniform. Also an advantage to the use of the shadow is that you obtain a zenith distance. With a sextant you obtain an altitude and then have to convert that altitude to a zenith distance by subtracting the altitude from 90 degrees. For the spherical triangle problem uses zenith distances for the solution.

In the art of celestial navigation, the sextant is the main tool and the charts, or the computer/calculator aided data are the means of making any sense of the what is derived from the sextant. In using the sextants and charts you obtain a line of position. So your position is somewhere on that line. Which goes in a circle around the world. Then another sighting of a celestial body gives another line of position, and supposedly your position is where they cross. But we find that if we take another sighting of a celestial body that we form a triangle and our position is somewhere in that triangle.

In this Mechanical Celestial Navigational and Directional device the same variables are used as in the conventional celestial navigation, (time, hour angle, declination, direction, altitude), only with a slightly different reference (time, longitude of celestial body, latitude of celestial body, and direction). Which is then instead of going to massive complicated charts you go to this device and solve the spherical triangle problem to give you your positions latitude and longitude. The weakest part of the solution is the direction found using the magnetic compass in obtaining the azimuth, of the celestial body.

I mentioned that the weakest part of the celestial navigation solution is the use of the magnetic compass to find the azimuth of the celestial body. This can be overcome by using the suns shortest shadow as pointing south, or a sighting of the north star. This direction can be transported by way of the gyros, to improve the accuracy of the position gained from this mechanical celestial navigation device.

The back-up to the modern Global Positioning System and computer navigation needs to be more reliable and a help instead of a mystery.

In other art, there is the sun-dial. The sun-dial as a yard ornament is very decorative and accurate two days a year, and only fairly accurate two weeks in each year.

Why not have a yard ornament that with one adjustment will give not only accurate sidereal time for your longitude, but give the accurate local time, or any time zone in the world? Why not? You have your known positions latitude and longitude, you know the suns latitude (declination), and the suns azimuth. The only variable left is the suns longitude. This invention solves the spherical triangle problem giving you that longitude, which then gives you your time at your longitude, and your time zones time as well as all time zones. The reference to time and longitude is the definition that the sun is directly overhead the meridian at 1200 hours.

This invention started when I needed a magnetic compass fixed on the airplane that I was to fly on my trip. While maintenance was working on it I noticed the sun and the Boy Scout technic to use the hands of your watch and the sun you could find north. That spiked my interest and I started researching the subject and trying various things. The Boy Scout technic was very rough and not accurate enough to navigate with. I soon left it and have forgotten the details for this was in 1991. If I understand the sun compass watches technic, they have a special arm that you point to the sun and use the boy scout type technic to find north.

I first found out that I needed to display the compass rose counter clockwise instead of the normal clockwise orientation. The next thing I learned was that I needed the azimuth of the sun. For a long time using the azimuth obtained from the computer I realized that I had very accurate direction indication, but I was having to get the azimuth from a computer, and I wanted to have it in one device. That seemed like the hardest part to figure out. That is when I discovered all the specialized charts and graphs that others had tried. I tried eclipses, and sun equations of time to find my own magic graph that would give me the azimuth. Then thanks to inspiration it came to me how to find the azimuth. In developing this device I then found that it solved the navigation problems using the sun, and its shadow, and that the shadow gave me the zenith distance. This invention not only solves the spherical triangle problems but it gives a visual representation of the solution educating the user on navigational matters.

### OBJECTS OF THE INVENTION

One object of the invention is to allow for a back-up navigational method that is accurate and dependable. Even without the massive charts.

Another object of the invention is to provide a reliable solar compass, that can be used anywhere on the earth, and while moving.

Yet another object is to solve navigational problems with spherical triangle solutions.

Still another object is to reduce or eliminate the dependance on computers and calculators for navigational and celestial computations. For example: Position finding, celestial body locating, sidereal time, time zone times, direction finding, sun rise and set times.

Another object of the invention is to allow for celestial bodies to be used for direction finding at night.

### DISCLOSURE OF THE INVENTION

This invention is a mechanical celestial navigation and directional device that solves celestial spherical triangle problems, allowing a person to find; position, direction orientation, time, rise and set times, altitude and azimuth solutions, course and distance. In essence it can solve for any variable of a spherical triangle problem knowing the other variables.

This is attained by the following members:

A flat compass rose with a gnome protruding out of the center of it. This allows the shadow to be cast on the compass rose, indicating the direction the complete device is pointing.

This is then positioned on top of the flat vertical structural plane passing thru the north south line of the compass rose and the base compass roses north south orientation, and is perpendicular to both compass roses. With a circle cut out of the vertical structure to allow a gimbal type apparatus to pitch and spin along it's longitudinal axis. This plane is used to set or find the latitude of the observer, and represents the meridian plane the observer is on. This vertical structural plane is called the meridian plane latter on.

A base that has a compass rose printed on it, the north south line of the rose is alined with the longitudinal axis of the base. The compass rose of the base is used in finding or setting the celestial bodies azimuth. The flat structural plane mentioned above is then attached perpendicular to this base so its longitudinal axis is alined with the north south axis of the compass rose, and the longitudinal axis of the base, and the lateral axis of the flat structural plane is perpendicular to the bases lateral axis. With the compass rose on top of the vertical structural plane, and these two attached to the base the assembly looking head on would appear to be an “I” beam.

Then with columnar structural supports a gimbal type apparatus is mounted to lay in the circle cut out of the meridian plane.

The gimbal type device has a ring that is supported by the columnar supports. The ring itself supports the rotatable axis of the celestial body latitude circular disc, the time circular disc, and the longitude setting disc.

The celestial body latitude circular disc represents the bodies meridian that it is on. The latitude of the celestial body is set or displayed on this disc. This disc also has dates printed on it used to set the position of the sun based on the date of the year.

Bisecting the celestial meridian disc are two discs perpendicular to the celestial meridian disc. The larger disc has the time printed on it, and is used to set or display the time of whichever longitude the time is based on. I.e. the longitude of the time zone is set across from the accurate time. The smaller disc lays concentric to the disc and is displayed with all the longitudes around the earth on it. For example I live in the mountain time zone, and my local time is set across from the 105^{th} longitude while I am using mountain standard time, and 90^{th} longitude while using mountain daylight time. By the way sidereal time is displayed across from the local longitude.

So far we have the fixed meridian plane with a base below and a compass rose on top of it. We also have the moveable gimbal type apparatus, used to set the observers time with the observers longitude, and the celestial bodies latitude and longitude.

This all sits as one unit on top of and attached so as to allow it to rotate around an aiming platform. This aiming platform is the piece that gets aimed in the direction to be determined, or is what the celestial bodies azimuth is set to or determined. This aiming platform is what the suns position and the observers position are alined with and determine or sets the azimuth of the celestial body.

There are two pieces to this device that are separate and not attached to the device. They are used to set and/or determine zenith distances.

The one is a circular disc with calibrated concentric circles printed on it such that when it is placed over the top compass rose the gnome casts a shadow on it. The end point of the shadow then lays on the zenith distance indicating its value. This then is used in finding position.

The other separate piece is a circular ring with degrees marked on it that can be positioned so as to measure or set the zenith distance on the gimbal apparatus.

In practice the sun is the most common celestial body. To use this device the date is set on the celestial meridian disc giving the suns latitude. The celestial body meridian disc is rotated to bisect the time disc so that it is at the 1200 noon time mark. The time that the observer is using is set across from the longitude that the time zone is based on. The observers longitude is then set by rotating the complete gimbal to have the vertical disc (meridian disc) set on that longitude. With the vertical meridian disc being fixed the bottom of the circular hole in the meridian disc represents the observers position. The observers latitude is then set by pitching the gimbal so that the southern end of the gimbal axis points at the observers latitude marked on the meridian disc. Once all these variables are set the whole device from the base up is rotated around the aiming platform to aline the suns position (or celestial bodies position) and the observers position with the aiming marks on the platform. The direction the platform is pointing is then displayed by the shadow laying on the direction radial on the top compass rose.

To find an observers position the date and time are set the same as mentioned above. The celestial bodies meridian disc is set on the 1200 noon mark of the time disc to set the suns longitude. The suns azimuth is alined with the aiming platform and the suns zenith distance is determined from the zenith distance disc or from a sextant. (You have to convert the altitude given by the sextant to the zenith distance by subtracting it from 90 degrees.) Then you rotate the gimbal assembly maintaining the settings and keeping the suns position lined up with the aiming platform till you have rotated the gimbal apparatus to have the suns position match the suns zenith distance, using the zenith distance setting ring.

To summarize: This invention can determine observers position, direction orientation, time, azimuth, zenith distance, great circle course, great circle distance, rise and set times, and celestial bodies azimuth, and zenith distance. It is very versatile. It is to celestial navigation, and spherical triangles what the slide rule is to mathematics.

### BRIEF DESCRIPTION OF THE DRAWINGS

The accompanying drawings, which are incorporated in and form a part of this specification, illustrate the invention and, together with the description, serve to give a picture of the invention:

FIG. 1: Profile View; Mechanical Celestial Navigational and Directional Device.

FIG. 2: Top View; Mechanical Celestial Navigational and Directional Device.

FIG. 3: Detailed View of; Bases compass rose—item 1, and top circular disk—item 8.

FIG. 4: Detailed View of; Time circular disk—item 5, and Longitude circular disk—item 6.

FIG. 5: Detailed View of; Latitude scale—Item 7.

FIG. 6: Detailed View of; Zenith distance measure circular disc—Item 12.

FIG. 7: Detailed View of; Zenith distance setting, and indicating tool—Item 11.

FIG. 8: A rotated quartering view of Invention.

FIG. 9: A top view of actual device.

### DESCRIPTION

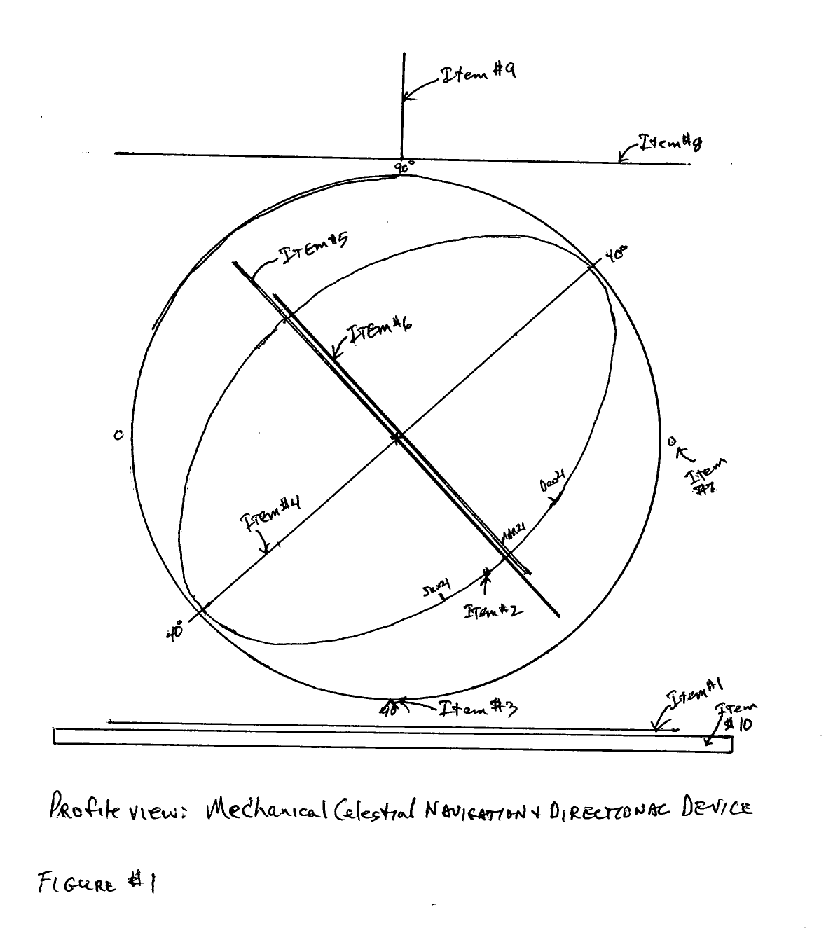

FIG. 1: Mechanical Celestial Navigational and Directional Device. Profile View
Item 1: Base with a circular disc, with an adjusted compass rose imprinted or pasted on the disc, where the degrees are incremented counter clockwise around the disc.
Item 2: Suns position indicator, in the shape of a circle with the latitudes of the earth incremented on it with 90 degrees north on one end, incrementing the latitudes down to 0 degrees in the center or equatorial position. Then continuing on in negative numbers representing the southern latitudes, to 90 degrees at the south pole. This circular disc is attached to an axis that is turned when setting the time, and the suns position is set while sliding the date indicator along the edge of this circular disc.
Item 3: The observers position indicator is fixed at the center of the bases compass rose, and at the bottom of the cut out circle in the vertical plane/observers meridian plane.
Item 4: Suns/Celestial bodies meridian indicator, in the shape of a circle with the latitudes of the earth incremented on it with 90 degrees north on one end, incrementing the latitudes down to 0 degrees in the center or equatorial position. Then continuing on in negative numbers representing the southern latitudes, to −90 degrees at the south pole. This circular disc is attached to an axis that is turned when setting the time, and the suns position is set while sliding the date indicator along the edge of this circular disc.
Item 5: Time circular disc, mounted perpendicular to the celestial body meridian disc that has the hours of the day marked around its circumference. The celestial body meridian disc is fixed to this time disc at the 1200 hour (noon) position. Indicating the rotation of the earth. Wherever the sun is zenith to the earth, that longitude is noon.
Item 6: Longitude circular disc, mounted concentric to the time disc, and attached to the inner concentric axis. This disc has the longitudes of the earth marked around the circumference of the longitude concentric disc. This disc is used to set the times longitude against the time on the outer circular disc, and also to set the longitude of the observer to the observers position indicator that is perpendicular to the base disc.
Item 7: Vertical structural member that the latitude scale is printed on. The top compass rose disc sits on top of and is affixed to this member, and this member is fixed to the base.
Item 8: The compass rose disc. It has a gnome mounted in the center of this disc, with an adjusted compass rose imprinted or pasted on the disc, where the degrees are incremented counter clockwise around the disc. The shadow of the gnome then casts a shadow across this compass rose disc. This top compass rose disc is also fixed permanently to the vertical structural member to keep it's orientation to the bottom base circular disc.
Item 9: Gnome, a known height needle like shadow generator, that is mounted perpendicular to the top circular disc.

All of the above items are then mounted to:
Item 10: An aiming platform that the above rotates around. Mounted center of the mounting base and center of the above device. This device can have aiming devices on it to facilitate what landmarks are in that direction.

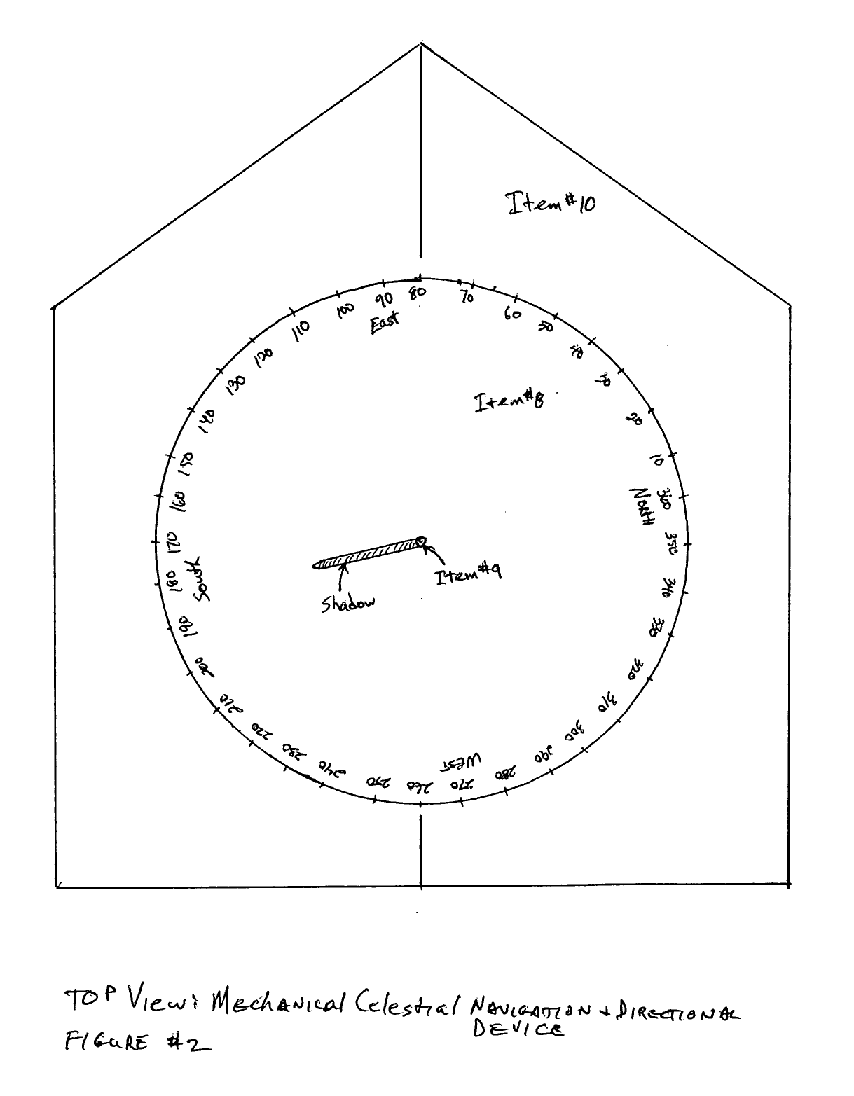

FIG. 2: Mechanical Celestial Navigational Computer. Top View.

FIG. 2: Top View; Mechanical Celestial Navigational and Directional Device.

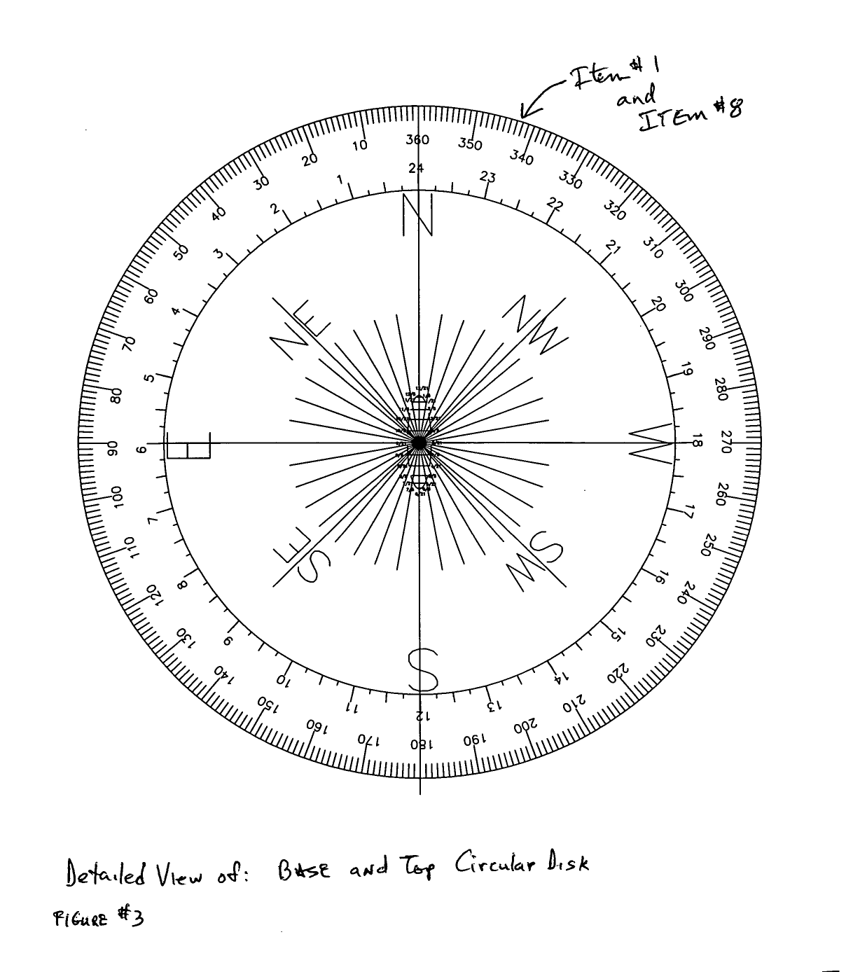

FIG. 3: Detailed View of; Bases compass rose—item 1, and top circular disk—item 8.

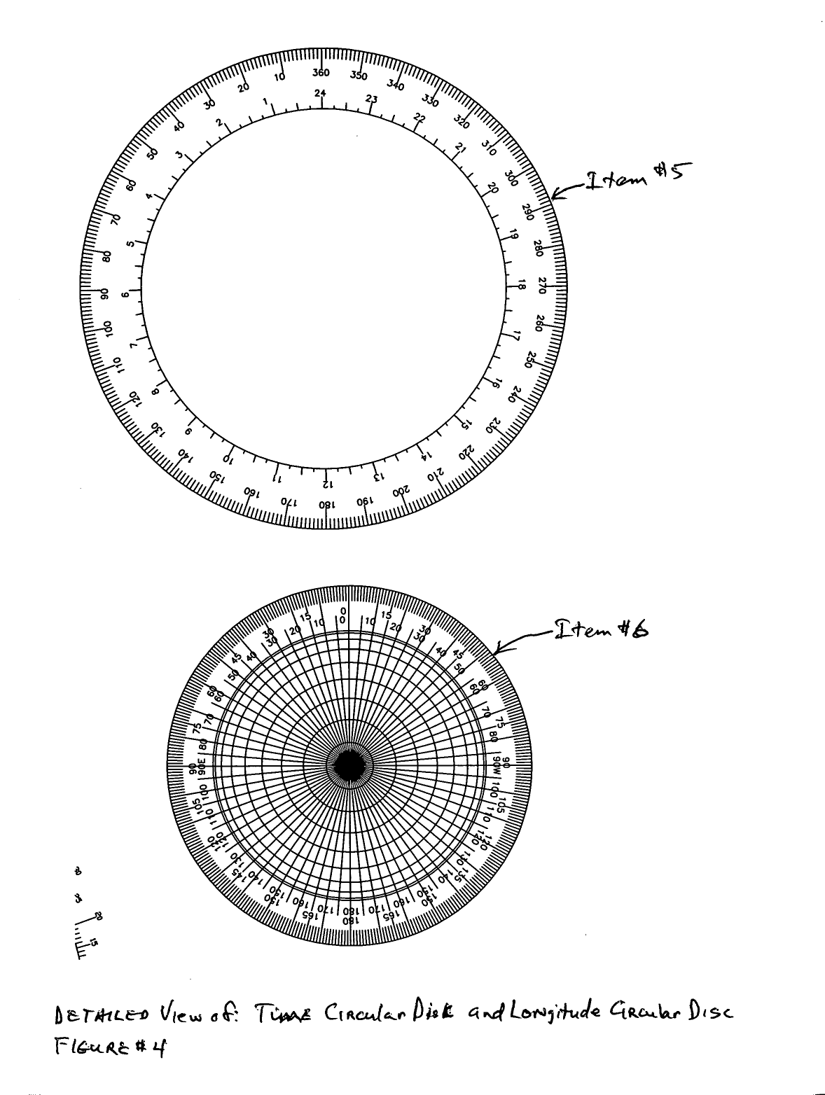

FIG. 4: Detailed View of; Time circular disk—item 5, and Longitude circular disk—item 6.

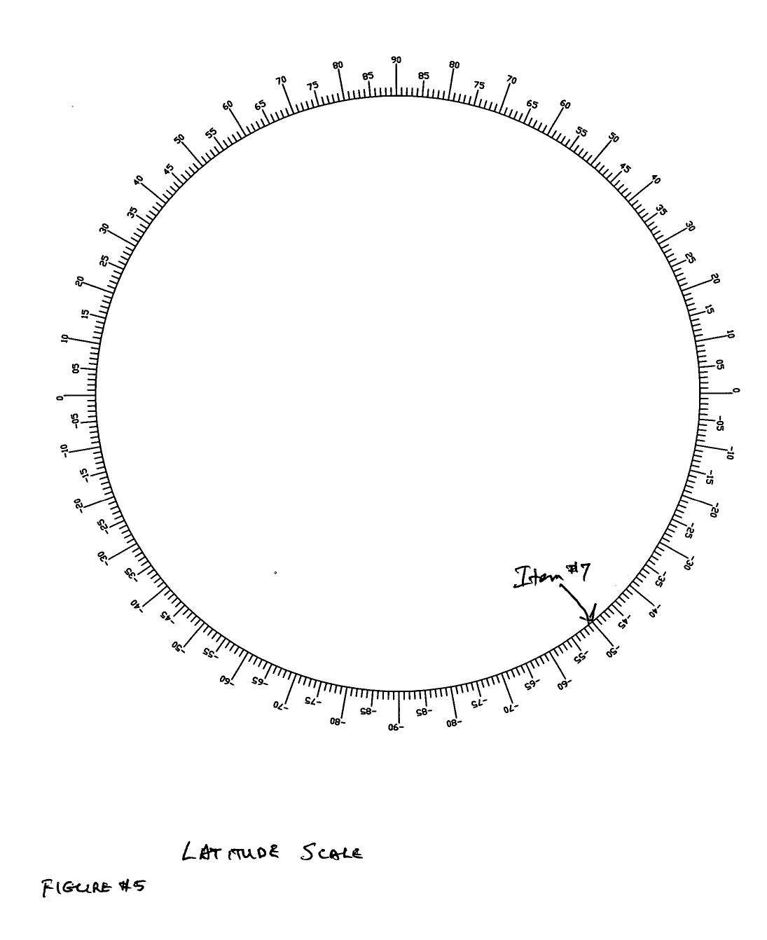

FIG. 5: Detailed View of; Latitude scale—Item 7.

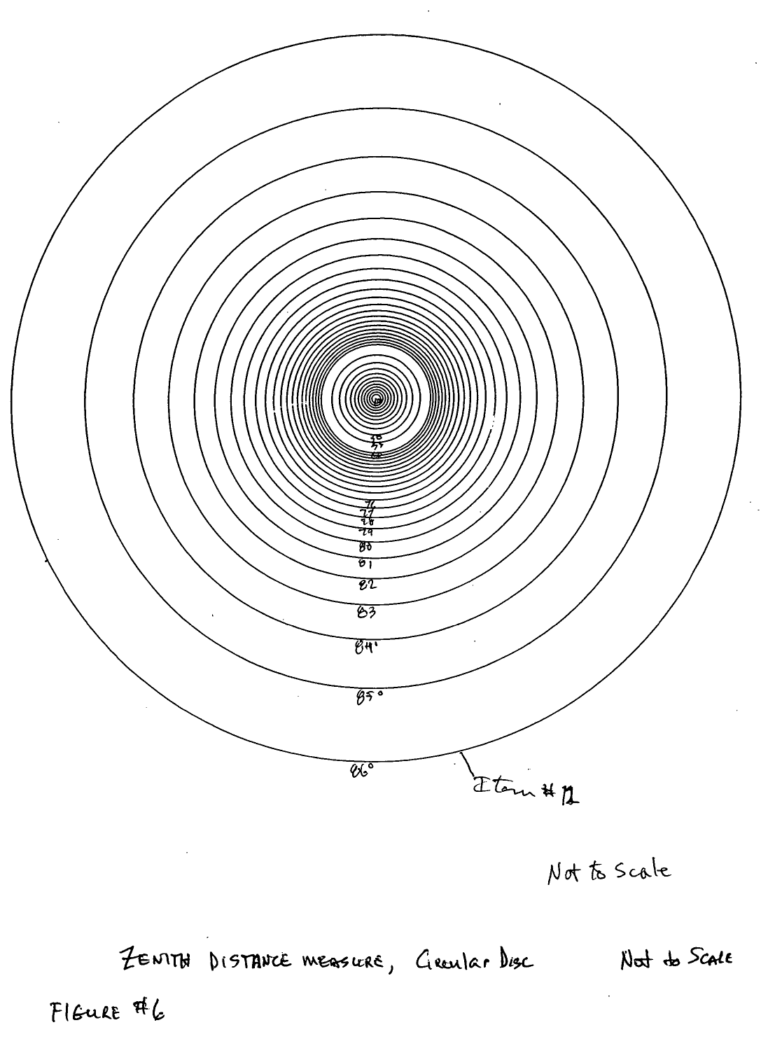

FIG. 6: Detailed View of; Zenith distance measure circular disc—Item 12.
Item 12: An alternate top circular disc that has concentric circles of degrees marked on its face so that the length of the shadow indicates the zenith distance of the sun from the observer. Therefor allowing the determination of position on the earth.

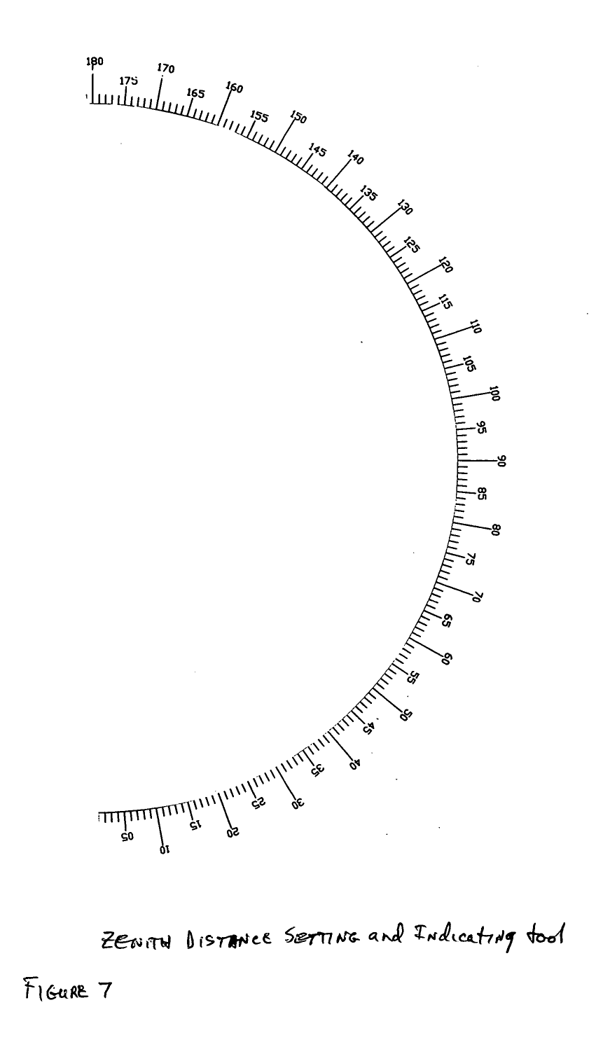

FIG. 7: Detailed View of; Zenith distance setting, and indicating tool—Item 11.
Item 11: An independent degree scale that is used to measure a zenith distance. This is used in determining position from data gained from this device.

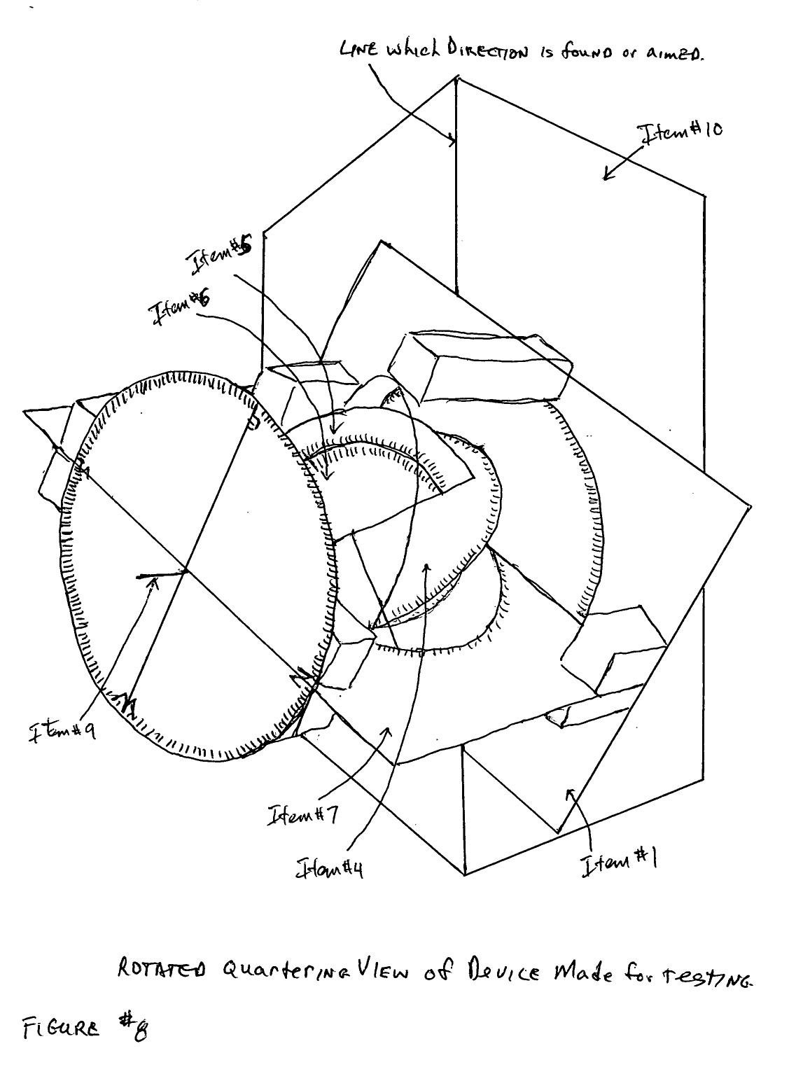

FIG. 8: A rotated quartering view of Invention.

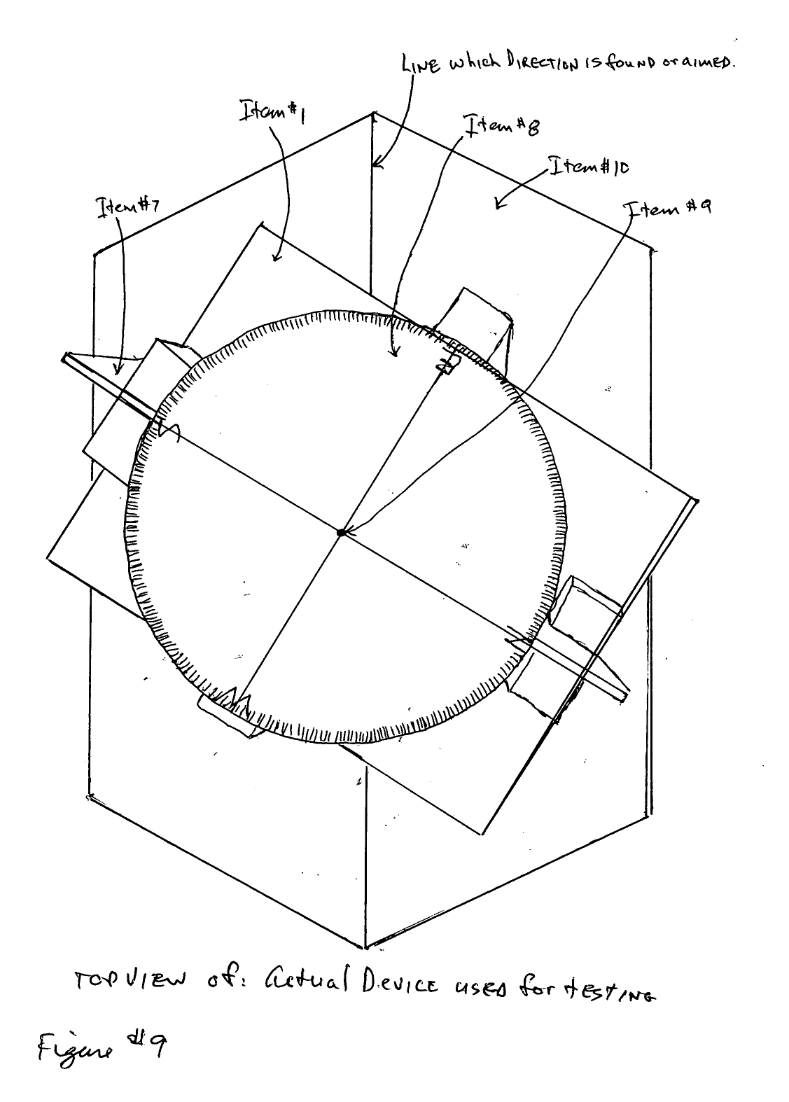

FIG. 9: A top view of actual device.

To have a mechanical celestial navigation and directional device that solves celestial spherical triangle problems, allowing a person to find; position, direction orientation, time, rise and set times, altitude and azimuth solutions. In essence it can solve for any variable of a spherical triangle problem knowing the other variables.

1. An aiming platform with alignment points which point in the direction to be determined. When used in a vehicle this platform is mounted so the longitudinal axis of this device is parallel to the longitudinal axis of the vehicle. When used in hand, it is pointed in the direction that we want to determine.

2. A base with a compass rose with the degrees 0 thru 360 incremented counter clockwise around the circle is used to find or set the celestial bodies azimuth. The 360 degree mark and the 180 degree mark are alined to the longitudinal axis of this base and in the center of the base. There is a pivot point in the center of the compass rose for mounting to the aiming platform mentioned in 1 above. This base also supports structural members used to support the remainder of the devices members.

3. A vertical plate mounted perpendicular to the base with its longitudinal axis parallel to the base's longitudinal axis, and the lateral axis perpendicular to the base's lateral axis. Also this discs longitudinal axis is alined with the bases compass rose north south line. This plate has a circle cut out of it for the tipping and rotating of the gimbal type apparatus inside of it. Around the rim of the hole is incremented the latitude degrees, with the positive 90 degree (north pole) being oriented upward, and the negative 90 degree (south pole) being oriented downward. This vertical plate is used to set or display the latitude of the observer. It represents the meridian plane of the observer.

4. A circular ring which is supported by two columnar structural members mounted so the axis of the circular ring is perpendicular to the vertical plates lateral axis at a height that enables the ring to rotate 360 degrees inside the vertical plate. The other axis of the ring houses the axis of the time, longitude, and celestial body latitude setting members. This ring rotates to set the latitude of the observer by the latitude marked on the vertical plate.

5. A structural axis member which forms the axis of the time, longitude, and celestial body latitude setting members. This axis southern hemisphere end, points to the latitude on the vertical plate of the observer, and allows the time, longitude, and celestial body latitude setting members to rotate around this axis to set the variables on them. This axis is alined parallel to the vertical plate and rotates parallel to the vertical plate.

6. A circular disc with latitude degrees incremented on both sides. Starting with 0 degrees and incrementing counter clockwise upward to 90 degrees then incrementing still counter clockwise down to 0 degrees, and incrementing counter clockwise down to −90 degrees then incrementing counter clockwise up to return to the original 0 degrees. The positive 90 degrees representing the north pole. The negative 90 degrees represents the southern pole, with the two zero degrees forming the equatorial line. The axis passing thru the 90 degree increments is aligned parallel to the structural axis, and the plane of the vertical plate. The date is also incremented on this disc with June 21^{st} being on the 23.5 degree latitude, and December 21 on the negative 23.5 degree latitude, with the rest of the days of the year being annotated along their respective latitudes that the sun will be at. There are two slots cut along the equatorial axis of this circular disc to allow the time disc and the longitude disc to be mounted perpendicular to this discs plane. This disc is used for setting the celestial bodies latitude, therefor being called the celestial body latitude disc, or celestial body meridian disc.

7. A circular disc with time incremented counter clockwise from 0 (midnight) to 24 hours in as small intervals as is possible. (The larger the device the more intervals therefor the device is more accurate). The time increments diameter coincides with the longitude disc diameter. This disc is mounted to the structural axis, with the structural axis passing perpendicular thru a hole in the center of this circular disc. This disc is also mounted flat (parallel) to the longitude disc to be discussed next. This disc is used to set the time, across from the longitude associated with that time, i.e. local time is set across from the longitude for that time zone.

8. A circular disc with degrees of longitude incremented around its circumference. With the east longitudes starting with 0 incrementing counter clockwise thru 180 degrees, and the west longitudes starting with 0 incrementing clockwise thru 180 degrees. This disc has a hole in the center and mounts so as to be concentric with the time disc, and the diameter of this longitude disc coincides with the inside diameter of the time disc. This disc is then mounted together with the time disc so as to cut perpendicular thru the equatorial axis of the celestial body latitude disc. This disc is used to set the time across from the longitudes on this disc.

9. The celestial body latitude disc, the time disc, and the longitude disc are then mounted on the structural axis into the circular ring mentioned in four allowing this assembly to rotate around this structural axis inside the ring. Then this ring can also pitch to indicate the latitude of the observer on the vertical structural member.

10. A circular compass rose disc with the degrees 0 thru 360 incremented counter clockwise around the circle similar to the compass rose on the base. There is a gnome in the center of the compass rose for casting a shadow on this compass rose. The degree radial that the shadow lays on is the direction that the aiming platform is pointing to. The degree radial is not the direction that the shadow is pointing. The shadow is also not pointing north. The only time that any member of this device is pointing north is when the aiming platform is pointed north. This compass rose disc is mounted perpendicular to and on top of the vertical structural member in a manner so that the north south axis of this disc is alined parallel with the longitudinal axis of the vertical structural member, and so that this disc's north south axis is alined parallel to and in the same orientation as the base's compass rose. Resulting in these two compass roses structural planes being parallel to each other, and with the vertical structural member's structural plane being perpendicular to and mounted between the two compass roses.

11. A circular disc that is mountable over the compass rose disc and detachable, with concentric circles drawn upon its face. These concentric circles are calibrated to indicate in degrees the zenith distance of the sun, or other shadow casting celestial body. When this disc is laid over the compass rose the gnome protrudes thru it and is a specific height above it, therefor the length of the shadow is known and is indicated in degrees of zenith with the concentric circles. The end point of the shadow indicates the degree of zenith of the shadow casting celestial body.

12. A tool in the shape of a halved ring, with degrees incremented on it from 0 to 180. This tool is used to set or measure the zenith distance of the celestial body on the device. For celestial body solutions only 0 thru 90 degrees is useful because of our line of sight. For spherical triangle solutions 0 thru 180 degrees are needed.
